(19) United States
(12) Patent Application Publication
(10) Pub. No.: US 2026/0044176 A1
(43) Pub. Date: Feb. 12, 2026

(54) CURRENT DISTRIBUTION SYSTEM

(71) Applicant: NORTHROP GRUMMAN SYSTEMS CORPORATION, FALLS CHURCH, VA (US)

(72) Inventors: JAMES R. MEDFORD, COLUMBIA, MD (US); JACOB SMITH, GLEN BURNIE, MD (US); JEREMY B. CLARK, Washington Township, OH (US); JOEL D. STRAND, ELLICOTT CITY, MD (US); MICAH JOHN ATMAN STOUTIMORE, ROCKVILLE, MD (US); WILLIAM F. KOEHL, Thousand Oaks, CA (US)

(21) Appl. No.: 18/796,924

(22) Filed: Aug. 7, 2024

(51) Int. Cl. G06F 1/04

(52) U.S. Cl. CPC G06F 1/04

(57) ABSTRACT

One example includes a current distribution system. The system includes at least one resonator spine that propagates a sinusoidal current. The system also includes at least one resonator rib conductively coupled to the at least one resonator spine and arranged as a standing wave resonator with respect to the sinusoidal current. Each of the at least one resonator rib can have a length from a first end corresponding to the conductive coupling to a second end that corresponds to a half wavelength of the sinusoidal current.

### GOVERNMENT INTEREST

The invention was made under Government Contract. Therefore, the US Government has rights to the invention as specified in that contract.

### TECHNICAL FIELD

The present invention relates generally to computer systems, and specifically to a current distribution system.

### BACKGROUND

Typical circuits that implement logic functions can operate based on a clock to synchronize data and/or provide a time-based flow of the logic functions. Circuits that are based on complementary metal-oxide-semiconductor (CMOS) technology can implement a clock to indicate when a given logic circuit or gate is to capture data at one or more inputs for processing or transferring the data to other logic functions. A given clock can thus provide a clock signal to a variety of devices in the circuit to provide the requisite timing information, and thus to substantially synchronize data transfer and timing functions. Other types of circuits can implement clock signals, such as reciprocal quantum logic (RQL) circuits. RQL circuits can implement timing information based on a clock that is provided, for example, as a sinusoidal signal having a substantially stable-frequency.

### SUMMARY

One example includes a current distribution system. The system includes at least one resonator spine that propagates a sinusoidal current. The system also includes at least one resonator rib conductively coupled to the at least one resonator spine and arranged as a standing wave resonator with respect to the sinusoidal current. Each of the at least one resonator rib can have a length from a first end corresponding to the conductive coupling to a second end that corresponds to a half wavelength of the sinusoidal current.

Another example includes a current distribution system. The system includes at least one resonator spine that propagates a sinusoidal current. The system also includes at least one resonator rib conductively coupled to the at least one resonator spine and arranged as a standing wave resonator with respect to the sinusoidal current. Each of the at least one resonator rib can include a plurality of bends to provide an odd plurality of parallel portions of the respective one of the at least one resonator rib.

Another example includes a reciprocal quantum logic (RQL) circuit system comprising a clock distribution system. The clock distribution system includes at least one resonator spine that propagates a sinusoidal clock signal corresponding to one of an in-phase component and a quadrature phase component of an RQL clock signal. The system further includes at least one resonator rib conductively coupled to the at least one resonator spine and arranged as a standing wave resonator with respect to the sinusoidal clock signal. Each of the at least one resonator rib can include a plurality of bends to provide a plurality of parallel portions of the respective one of the at least one resonator rib. Each of the at least one resonator rib can have a length from a first end corresponding to the conductive coupling to a second end that corresponds to a half wavelength of the sinusoidal clock signal.

### BRIEF DESCRIPTION OF THE DRAWINGS

FIG. 1 illustrates an example of a circuit system.

FIG. 2 illustrates an example of a current distribution system.

FIG. 3 illustrates an example diagram of resonator current.

FIG. 4 illustrates another example diagram of resonator current.

### DETAILED DESCRIPTION

The present invention relates generally to computer systems, and specifically to a current distribution system. The current distribution system, as described herein, is arranged as a resonator “spine” and “rib” configuration. As described herein, the term “spine”, as pertaining to the resonator, describes a conductor that is configured to propagate a sinusoidal current. As an example, the sinusoidal current can correspond to a clock signal, such as one of the in-phase component or the quadrature-phase component of a reciprocal quantum logic (RQL) clock signal. The term “rib”, as pertaining to the resonator, describes a conductor that is conductively coupled to the spine and is arranged as a standing-wave resonator that propagates the sinusoidal current. The current distribution system can include a plurality of resonator ribs that are each conductively coupled to the same resonator spine, and thus can each separately propagate the sinusoidal current from the resonator spine.

Each of the resonator rib(s) can have a length from a first end that is conductively coupled to the resonator spine to a second end (e.g., a grounded distal end) that is approximately one half a wavelength of the sinusoidal current. Therefore, each of the resonator rib(s) can have a node at each end of the respective resonator rib and an anti-node at approximately half the length of the respective resonator rib. As an example, each resonator rib can be arranged to include a plurality X of bends, where X is an odd number greater than one. Based on the length of the resonator rib(s), and based on the odd quantity of the bends of the resonator rib(s), the magnetic field that is generated by the sinusoidal current propagating on the respective one of the resonator rib(s) is substantially cancelled. Accordingly, spurious magnetic fields that can facilitate errors and cross-talk in the respective circuit system and/or external circuit systems can be mitigated.

In addition, the current distribution system can include at least one inductive-coupling line that is conductively coupled to an associated circuit, such as an RQL circuit. The inductive-coupling line(s) are inductively coupled to the resonator rib(s) via a plurality of inductive couplings to inductively generate a current corresponding to the sinusoidal current to provide functions for the associated circuit. The inductive coupling of a given inductive-coupling line to a respective resonator rib is provided in a manner that mitigates non-uniformity of the induced clock current in the inductive-coupling line relative to a different inductive-coupling line inductively coupled to the same resonator rib. Accordingly, the resonator rib architecture described herein can facilitate uniform current (e.g., clock) distribution to each of the associated circuits while mitigating spurious magnetic fields within the associated circuit system.

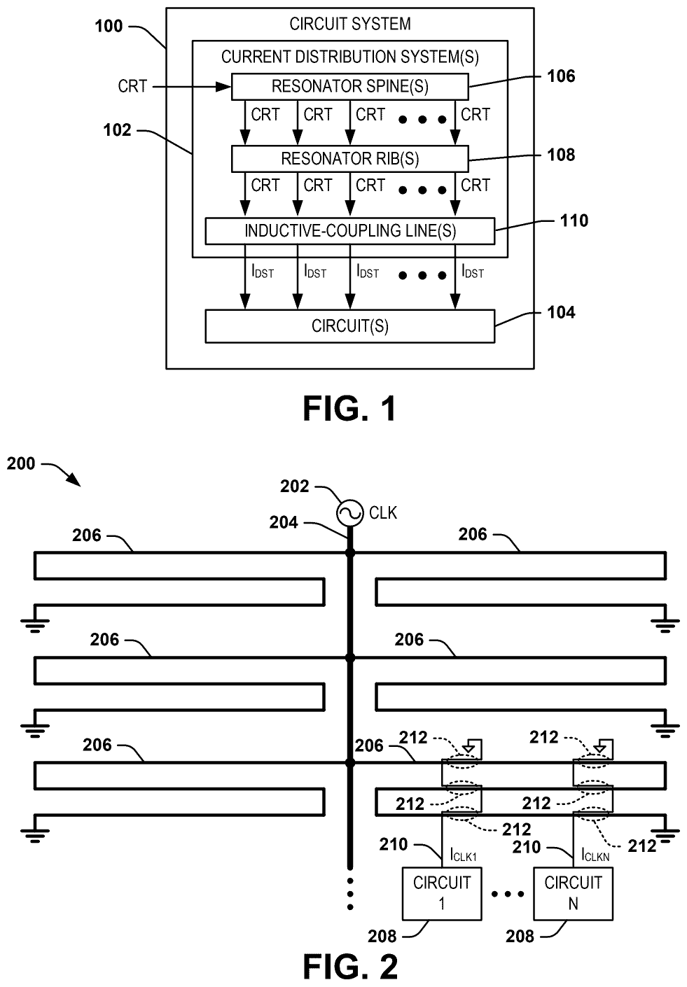

FIG. 1 illustrates an example of a circuit system 100. The circuit system 100 can correspond to any of a variety of circuits (e.g., integrated circuits (ICs)) in which a sinusoidal current is distributed for use in different parts of the circuit system 100. As an example, the circuit system 100 can be arranged as a reciprocal quantum logic (RQL) circuit, and can be implemented in or as part of an IC.

The circuit system 100 includes at least one current distribution system 102. The current distribution system(s) 102 can be configured to provide a sinusoidal current CRT to each of one or more circuits 104 that may be distributed across the circuit system 100, as described herein. In the example of FIG. 1, each of the current distribution system(s) 102 includes at least one resonator spine 106 and at least one resonator rib 108. The resonator rib(s) 108 are each conductively coupled to a given one of the resonator spine(s) 106. Thus, the sinusoidal current CRT, provided to the resonator spine(s) 106 (e.g., from a local oscillator), can be provided to propagate on each of the respective resonator rib(s) 108.

In the example of FIG. 1, the current distribution system 102 also includes at least one inductive-coupling line 110. Each of the inductive-coupling line(s) 110 can be inductively coupled to one or more of the resonator rib(s) 108 to inductively provide a current I_{DST} to an associated one of the circuit(s) 104. Particularly, the inductive-coupling line(s) 110 are inductively coupled to the respective resonator rib(s) 108 via a plurality of inductive couplings to inductively generate the current I_{DST} to provide functions (e.g., timing functions and/or power distribution functions) for the associated circuit(s) 104. As an example, the current I_{DST} can correspond to a clock signal, such as one of the in-phase component or the quadrature phase component of an RQL clock signal. Based on the multiple inductive couplings of a given one of the inductive-coupling line(s) 110 to a respective one of the resonator rib(s) 108, non-uniformity of the induced current I_{DST} in the given one of the inductive-coupling line(s) 110 relative to a different one of the inductive-coupling line(s) 110 that is likewise inductively coupled to the same resonator rib(s) 108 can be mitigated.

Each of the resonator rib(s) 108 can have a length from a first end that is conductively coupled to the respective one of the resonator spine(s) 106 to a second end that is approximately one half a wavelength (λ/2) of the sinusoidal current CRT. Therefore, each of the resonator rib(s) 108 can have a node at each end of the respective resonator rib and an anti-node at approximately half the length of the respective resonator rib 108. As an example, each resonator rib 108 can be arranged to include a plurality X of bends, where X is an odd number greater than one (e.g., N=3). Based on the length of the resonator rib(s) 108, and based on the odd quantity of the bends of the resonator rib(s) 108, the magnetic field that is generated by the sinusoidal current CRT propagating on the respective one of the resonator rib(s) 108 is substantially cancelled. Accordingly, spurious magnetic fields that can facilitate errors and cross-talk in the respective circuit system 100 and/or to circuits external to the circuit system 100 can be mitigated.

For example, one or more of the resonator rib(s) 108 can be fabricated in the circuit system 100 as proximal to a ground plane or to one of the circuit(s) 104 and/or circuits external to the circuit system 100 that may be sensitive to noise resulting from a spurious magnetic field. Therefore, the magnetic field generated from the sinusoidal current CRT propagating on the respective resonator rib(s) 108 can have substantially no effect on the circuit(s) 104 of the circuit system 100 and/or circuits external to the circuit system 100. Accordingly, the current distribution system(s) 102 can provide greater mitigation of spurious magnetic fields than a conventional clock distribution system that includes quarter-wave resonators.

FIG. 2 illustrates an example of a current distribution system 200. The current distribution system 200 can correspond to one of the current distribution system(s) 102 in the example of FIG. 1. Therefore, reference is to be made to the example of FIG. 1 in the following description of the example of FIG. 2. In the example of FIG. 2, the sinusoidal current CRT is demonstrated as a clock signal CLK, and the induced current is demonstrated as a clock current I_{CLK}.

The current distribution system 200 includes a signal source 202 that is configured to provide the clock signal CLK. The signal source 202 is coupled to a resonator spine 204 that is arranged as a conductor to propagate the clock signal CLK. In the example of FIG. 2, the current distribution system 200 includes a plurality of resonator ribs 206 that are conductively coupled to the resonator spine 204 to likewise propagate the clock signal CLK. As an example, each of the resonator ribs 206 can be configured as standing-wave resonators, such that each of the resonator ribs 206 can have a physical length that is approximately equal to a predetermined length associated with a wavelength of the clock signal CLK. For example, each of the resonator ribs 206 can have a total length “L” from a first end corresponding to the conductive coupling to the resonator spine 204 to a second end that is coupled to a low-voltage rail (e.g., ground) that is approximately equal to one-half of the wavelength, of the clock signal CLK (i.e., λ/2). Therefore, based on the standing-wave resonator configuration of the resonator ribs 206, the clock signal CLK can have a magnitude that is greatest at half the length L of the resonator rib 206, and is least at each of the ends.

In the example of FIG. 2, a plurality N of circuits 208 are each demonstrated as inductively coupled to one of the resonator ribs 206 via a respective inductive-coupling line 210. The inductive coupling of the respective circuits 208 to the resonator rib 206 is provided through a plurality of inductive couplings 212 associated with each respective inductive-coupling line 210. In the example of FIG. 2, the multiple inductive couplings 212 of each inductive-coupling line 210 are provided based on the resonator rib 206 including multiple bends (e.g., rounded or angular) to provide three parallel portions 214 of the resonator rib 206. Therefore, a first of the parallel portions 214 extends from the resonator spine 204, bends 180° back toward the resonator spine 204, and bends 180° again to provide the grounded-end of the resonator rib 206 to be distal with respect to the resonator spine 204. While the example of FIG. 2 demonstrates three parallel portions 214, the current distribution system 100 described herein can include an odd number quantity of parallel portions 214 that is more than three.

As described herein, each of the inductive couplings 212 is between a respective inductive-coupling portion of the inductive-coupling line 210 and a portion of the resonator rib 206 (e.g., an extension along one of the parallel portions 214 of the resonator rib 206). Therefore, each of the inductive couplings 212 provides a portion of the clock signal CLK to be induced as a portion of respective clock currents I_{CLK1} through I_{CLKN} that are provided to the respective circuits 208. Thus, the inductive couplings 212 inductively provide the clock currents I_{CLK} corresponding to the clock signal CLK to the circuits 208 in an additive manner with respect to each of the parallel portions 214. Based on the bends of the resonator rib 206, the additive manner of the inductive generation of the clock currents I_{CLK} can be such that each of the clock currents I_{CLK1} through I_{CLKN} can be approximately uniform with respect to the circuits 208.

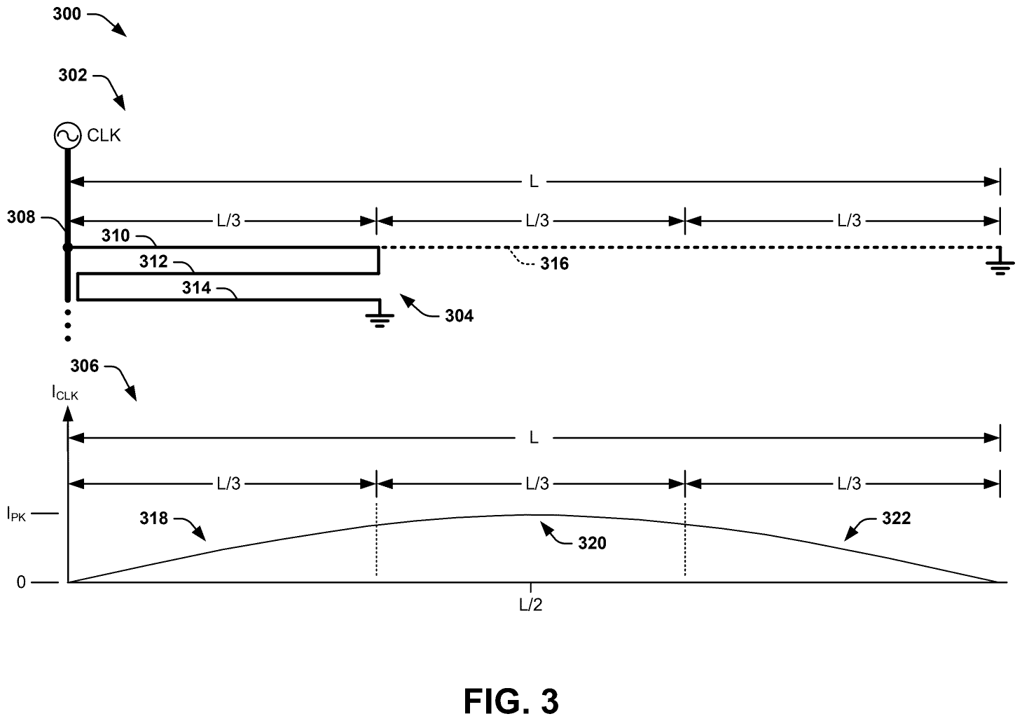

FIG. 3 illustrates an example diagram 300 of resonator current. The diagram 300 of the resonator current can correspond to the clock signal I_{CLK} in the example of FIG. 2. Therefore, reference is to be made to the example of FIG. 2 in the following description of the example of FIG. 3.

The diagram 300 demonstrates a first portion 302 that illustrates a resonator rib diagram 302 that includes a resonator rib 304, and also illustrates a current diagram 306. The resonator rib 304 is demonstrated as coupled to a resonator spine 308, such that the resonator rib 304 can correspond to one of the resonator ribs 206 and the resonator spine 308 can correspond to a portion of the resonator spine 204, respectively, in the example of FIG. 2. Particularly, in the example of FIG. 3, the resonator rib 304 is conductively coupled to the resonator spine 308 and includes a grounded end opposite the conductive coupling to the resonator spine 308. The resonator rib 304 is demonstrated as both having parallel portions and as fully extended to the length “L” as demonstrated by the dotted line 316. In the example of FIG. 3, the resonator rib 304 is demonstrated as having a first parallel portion 310 that extends from the resonator spine 308, a second parallel portion 312 that bends back toward the resonator spine 204, and a third parallel portion 314 that bends away from the resonator spine 204.

Thus, the length “L” is representative of a full length of the resonator rib 304 if the resonator rib 304 was fully extended in a linear, unbent manner. The resonator rib 304 having the three parallel portions is thus demonstrated as extending from the resonator spine 308 at a distance of L/3, one third the length L of the unbent representation of the resonator rib 304.

The current diagram 306 demonstrates an amplitude of the clock current I_{CLK} as a function of the length “L” of the resonator rib 304. The length “L” of the current diagram 306 corresponds directly to the length “L” of the unbent, linear resonator rib 304 demonstrated by the dotted line 316. Therefore, the length “L” in the current diagram 306 extends from the conductive coupling of the resonator rib 304 to the resonator spine 308 and along the length of the resonator rib 304 to the grounded end. The current diagram 306 also demonstrates that the length L of the resonator rib 304 is divided into three equal lengths L/3 that each correspond to a respective one of the parallel portions 310, 312, and 314. Particularly, the first length L/3 can correspond to a first portion 318 of the clock current I_{CLK} in the first parallel portion 310, the second length L/3 can correspond to a second portion 320 of the clock current I_{CLK} in the second parallel portion 312, and the third length L/3 can correspond to a third portion 322 of the clock current I_{CLK} in the third parallel portion 314. In the example of FIG. 3, the clock current I_{CLK} has an amplitude I_{S} between the first and second lengths L/3, and thus between the first and second parallel portions 310 and 312, and between the second and third lengths L/3, and thus between the second and third parallel portions 312 and 314. The amplitude I_{S} is slightly less than (e.g., approximately 85% of) the maximum amplitude I_{PK}.

As demonstrated in the example of FIG. 3, the clock current I_{CLK} extends along the length “L” from left to right, and thus from the conductive coupling of the resonator rib 304 to the resonator spine 308 and along the length of the resonator rib 304 to the grounded end. Particularly, the clock current I_{CLK} increases from approximately zero amperes at the left, at the conductive coupling of the resonator rib 304 to the resonator spine 308, to a maximum amplitude I_{PK} at half the length L, and thus L/2, then back down to zero at the full length L corresponding to the grounded end. The amplitude of the clock current I_{CLK} is thus demonstrated as a half of a sinusoidal period, and thus a wavelength of λ/2 of the clock signal CLK. As an example, the relationship between the amplitude of the current and the position along the length of a given resonator rib can be approximately sinusoidal, reaching a maximum amplitude at the length L/2. Accordingly, the current diagram 306 demonstrates that the clock current I_{CLK} is non-uniform along the length of the resonator rib 304.

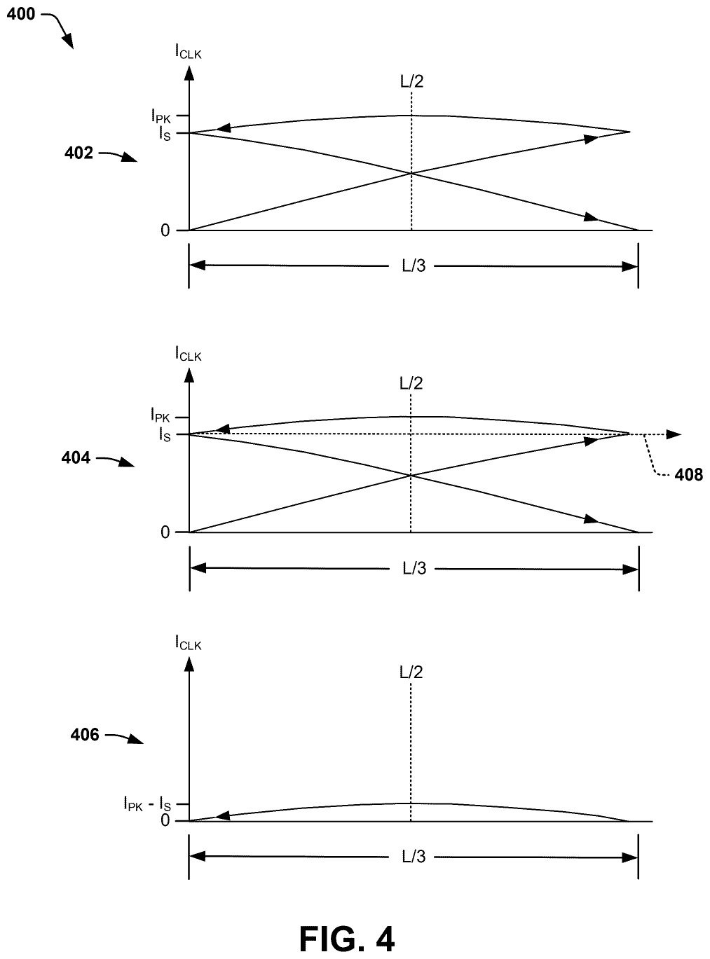

FIG. 4 illustrates another example diagram 400 of resonator current. The resonator current is demonstrated in a first graph 402, in a second graph 404, and in a third graph 406. The diagram 400 can correspond to a continuation of the description of the resonator current for the resonator rib 304 in the example of FIG. 3. Therefore, reference is to be made to the example of FIG. 3 in the following description of the example of FIG. 4.

The first graph 402 of the resonator current demonstrates the amplitudes of the first, second, and third portions 318, 320, and 322 of the clock current I_{CLK} superimposed on each other along a length L/3 of the resonator rib 304. Particularly, the first graph 402 corresponds to the respective amplitudes of the first, second, and third portions 318, 320, and 322 of the clock current I_{CLK} provided in the propagation direction and physical location along the respective first, second, and third parallel portions 310, 312, and 314 of the resonator rib 304 that extends at an approximately length L/3 from the resonator spine 308.

In the example of FIG. 4, the first portion 318 of the clock current I_{CLK} extends to the right, away from the resonator spine 308, from an amplitude zero at the resonator spine 308 to the amplitude I_{S} between the first and second parallel portions 310 and 312. The second portion 320 of the clock current I_{CLK} extends to the left, toward from the resonator spine 308, from the amplitude I_{S} at the length L/3 distal from the resonator spine 308, to the maximum amplitude I_{PK} in a center of the length L/3, and back to the amplitude I_{S} at approximately the resonator spine 308, and thus between the second and third parallel portions 312 and 314. The third portion 322 of the clock current I_{CLK} extends to the right, away from the resonator spine 308, from the amplitude I_{S} at the resonator spine 308 to the amplitude zero at the grounded end.

The second graph 404 of the resonator current also demonstrates the amplitudes of the first, second, and third portions 318, 320, and 322 of the clock current I_{CLK} superimposed on each other along a length L/3 of the resonator rib 304. However, the second graph 404 also includes a sum of the first and third portions 318 and 322 of the clock current I_{CLK} along the length L/3. Particularly, because the first and third portions 318 and 322 of the clock current I_{CLK} propagate in the same direction along the length L/3, the effects of the amplitudes of the first and third portions 318 and 322 of the clock current I_{CLK} are additive along the length L/3. In the example of FIG. 4, the additive sum of the first and third portions 318 and 322 of the clock current I_{CLK} is demonstrated as approximately the amplitude I_{S} along the length L/3 given that the first and third portions 318 and 322 of the clock current I_{CLK} are symmetrical about the half-length L/2 of the amplitude of the clock current I_{CLK}. Therefore, the additive sum of the first and third portions 318 and 322 of the clock current I_{CLK} is demonstrated as a dotted line 408 that is constant and approximately equal to the amplitude I_{S} along the length L/3. The additive sum of the first and third portions 318 and 322 of the clock current I_{CLK} can thus represent the additive sum of the magnetic fields that are generated by the first and third portions 318 and 322 along the length L/3.

As described above, the amplitude I_{S} of the clock current I_{CLK} is substantially similar to (e.g., approximately 85% of) the maximum amplitude I_{PK}. As demonstrated in the example of FIG. 4, the second portion 320 of the clock current I_{CLK} has an amplitude that starts and ends at the amplitude I_{S}, with an increase to the amplitude I_{PK} in the approximate center L/2 of the resonator rib 304. Therefore, the amplitude of the second portion 320 along the length L/3 is approximately equal to the additive amplitudes of the first and third portions 318 and 322 of the clock current I_{CLK} along the length L/3. However, because the second portion 320 of the clock current I_{CLK} propagates in the opposite direction relative to the first and third portions 318 and 322 of the clock current I_{CLK}, the amplitude of the second portion 320 is opposite the additive amplitudes of the first and third portions 318 and 322 of the clock current I_{CLK} along the length L/3. Therefore, the magnetic field generated by the second portion 320 of the clock current I_{CLK} is approximately equal and opposite the magnetic field generated by the first and second portions 318 and 322 of the clock current along the length L/3. Accordingly, the magnetic fields generated by the first, second, and third portions 318, 320, and 322 of the clock signal I_{CLK} substantially cancel each other.

The third graph 402 demonstrates the effective sum of the first, second, and third portions 318, 320, and 322 of the clock signal I_{CLK} with respect to the generation of the magnetic field. In the third graph 402, the effective sum of the first, second, and third portions 318, 320, and 322 of the clock signal I_{CLK} is demonstrated as the subtraction of the amplitude I_{S} from the second portion 320 of the clock current I_{CLK}. Therefore, the effective sum of the first, second, and third portions 318, 320, and 322 of the clock signal I_{CLK} are demonstrated as a difference between the second portion 320 of the clock current I_{CLK} and the amplitude I_{S} along the length L/3. The difference is thus demonstrated as varying between zero at each end of the length L/3 and the difference between the maximum amplitude I_{PK} and the amplitude I_{S} at the half-length L/2. Accordingly, the magnetic field that is generated by the effective sum of the first, second, and third portions 318, 320, and 322 of the clock signal I_{CLK} is substantially cancelled, and thus minimal with respect to potential effects on the circuits 208 of the circuit system 100.

As described above in the example of FIG. 2, the inductive couplings 212 inductively provide the clock currents I_{CLK} corresponding to the clock signal CLK to the circuits 208 in an additive manner with respect to each of the parallel portions 214. With reference to the first graph 402, each of the inductive-coupling lines 210 can provide the inductive couplings 212 in a direction that is commensurate with the propagation direction of the respective first, second, and third portions of the clock current I_{CLK}. Therefore, the inductive coupling 212 to the second portion 320 of the clock current I_{CLK} can be opposite the orientation of the inductive couplings 212 to the respective first and third portions 318 and 322 of the clock current I_{CLK} based on the opposite propagation direction of the second portion 320 of the clock current I_{CLK} relative to the first and third portions 318 and 322 of the clock current I_{CLK}. Accordingly, the inductive couplings 212 can be absolute value additive with respect to the induced current from all three of the portions 318, 320, and 322.

As another example, the inductive couplings 212 can all be arranged at a same position with respect to the length L/3 of the resonator rib 304 on each of the respective parallel portions 310, 312, and 314. Therefore, the absolute value additive sum of the currents of the portions 318, 320, and 322 can be approximately uniform across the length L/3 for each of multiple circuits 208 that are inductively coupled to a given one of the resonator ribs 206. Particularly, as demonstrated in the first graph 402, the sum of the amplitudes of the first and third portions 318 and 322 of the clock signal I_{CLK} is approximately equal to the amplitude I_{S} along the entire length L/3. As also described above, the amplitude of the second portion 320 of the clock current I_{CLK} varies little (e.g., from the amplitude I_{S} to the maximum amplitude I_{PK}) across the length L/3. Therefore, the difference between the absolute value additive sum of the induced current from the portions 318, 320, and 322 at a first position along the length L/3 is approximately equal to the absolute value additive sum of the induced current from the portions 318, 320, and 322 at any other position along the length L/3. Accordingly, the resonator rib 304 can provide approximate uniformity of the induced current for multiple circuits 208 along the length L/3.

What have been described above are examples of the invention. It is, of course, not possible to describe every conceivable combination of components or methodologies for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A current distribution system comprising:
at least one resonator spine that propagates a sinusoidal current; and
at least one resonator rib conductively coupled to the at least one resonator spine and arranged as a standing wave resonator with respect to the sinusoidal current, each of the at least one resonator rib having a length from a first end corresponding to a conductive coupling to the at least one resonator spine to a second end that corresponds to a half wavelength of the sinusoidal current.

2. The system of claim 1, wherein each of the at least one resonator rib comprises a plurality of bends to provide an odd plurality of parallel portions of the respective one of the at least one resonator rib.

3. The system of claim 2, further comprising at least one inductive-coupling line, each of the at least one inductive-coupling line being conductively coupled to an associated circuit and having an inductive coupling to each of the parallel portions of a respective one of the at least one resonator rib to inductively generate a current via the inductive couplings in an additive manner to provide functions for the associated circuit.

4. The system of claim 2, wherein the odd plurality of parallel portions of each of the at least one resonator rib are approximately equal in length and are arranged to cancel a magnetic field generated by the sinusoidal current on the respective one of the at least one resonator rib.

5. The system of claim 1, further comprising at least one inductive-coupling line, each of the at least one inductive-coupling line being conductively coupled to an associated circuit and having a plurality of inductive couplings to a respective one of the at least one resonator rib to inductively generate a current via the inductive couplings in an additive manner to provide functions for the associated circuit.

6. The system of claim 5, wherein each of the at least one resonator rib comprises a plurality of bends to provide an odd plurality of parallel portions of the respective one of the at least one resonator rib, wherein each of the at least one inductive-coupling line is inductive coupled to each of the parallel portions of the respective one of the at least one resonator rib.

7. The system of claim 1, wherein each of the at least one resonator rib comprises a plurality of bends to provide a plurality of parallel portions of the respective one of the at least one resonator rib, wherein the parallel portions are arranged to cancel a magnetic field generated by the sinusoidal current on the respective one of the at least one resonator rib.

8. The system of claim 7, wherein the bends are arranged to provide an odd plurality of the parallel portions of each of the at least one resonator rib.

9. The system of claim 7, wherein the parallel portions of each of the at least one resonator rib are approximately equal in length.

10. A reciprocal quantum logic (RQL) circuit system comprising the current distribution system of claim 1, wherein the sinusoidal current corresponds to one of an in-phase component and a quadrature phase component of an RQL clock signal.

11. A current distribution system comprising:
at least one resonator spine that propagates a sinusoidal current; and
at least one resonator rib conductively coupled to the at least one resonator spine and arranged as a standing wave resonator with respect to the sinusoidal current, each of the at least one resonator rib comprising a plurality of bends to provide an odd plurality of parallel portions of the respective one of the at least one resonator rib.

12. The system of claim 11, wherein the odd plurality of parallel portions of each of the at least one resonator rib are approximately equal in length.

13. The system of claim 11, wherein the odd plurality of parallel portions are arranged to cancel a magnetic field generated by the sinusoidal current on the respective one of the at least one resonator rib.

14. The system of claim 11, wherein each of the at least one resonator rib has a length from a first end corresponding to a conductive coupling to the at least one resonator spine to a second end that corresponds to a half wavelength of the sinusoidal current.

15. The system of claim 11, further comprising at least one inductive-coupling line, each of the at least one inductive-coupling line being conductively coupled to an associated circuit and having an inductive coupling to each of the parallel portions of a respective one of the at least one resonator rib to inductively generate a current via the inductive couplings in an additive manner to provide functions for the associated circuit.

16. A reciprocal quantum logic (RQL) circuit system comprising a clock distribution system, the clock distribution system comprising:
at least one resonator spine that propagates a sinusoidal clock signal corresponding to one of an in-phase component and a quadrature phase component of an RQL clock signal; and
at least one resonator rib conductively coupled to the at least one resonator spine and arranged as a standing wave resonator with respect to the sinusoidal clock signal, each of the at least one resonator rib comprising a plurality of bends to provide a plurality of parallel portions of the respective one of the at least one resonator rib, each of the at least one resonator rib having a length from a first end corresponding to a conductive coupling to the at least one resonator spine to a second end that corresponds to a half wavelength of the sinusoidal clock signal.

17. The system of claim 16, wherein each of the at least one resonator rib comprises a plurality of bends to provide an odd plurality of parallel portions of the respective one of the at least one resonator rib.

18. The system of claim 17, wherein the odd plurality of parallel portions of each of the at least one resonator rib are approximately equal in length.

19. The system of claim 17, wherein the odd plurality of parallel portions are arranged to cancel a magnetic field generated by the clock signal on the respective one of the at least one resonator rib.

20. The system of claim 16, further comprising at least one inductive-coupling line, each of the at least one inductive-coupling line being conductively coupled to an associated circuit and having an inductive coupling to each of the parallel portions of a respective one of the at least one resonator rib to inductively generate a current via the inductive couplings in an additive manner to provide functions for the associated circuit.
